(19) United States
(12) Patent Application Publication
(10) Pub. No.: US 2012/0092268 A1
(43) Pub. Date: Apr. 19, 2012

(54) COMPUTER-IMPLEMENTED METHOD FOR MANIPULATING ONSCREEN DATA

(75) Inventors: PEI-YUN TSAI, Tu-Cheng (TW); MIKE WEN-HSING CHIANG, Santa Clara, CA (US)

(73) Assignee: HON HAI PRECISION INDUSTRY CO., LTD., Tu-Cheng (TW)

(21) Appl. No.: 12/905,951

(22) Filed: Oct. 15, 2010

(51) Int. Cl. G06F 3/041

(52) U.S. Cl. 345/173

(57) ABSTRACT

A computer-implement method for manipulating onscreen data is disclosed. The method includes displaying content on a touch-sensitive display. A touch path is received from the touch-sensitive display. A command initiating path is identified from the touch path. At least one command operation is executed.

### CROSS-REFERENCE TO RELATED APPLICATIONS

Relevant subject matter is disclosed in co-pending U.S. patent applications entitled “COMPUTER-IMPLEMENTED METHOD FOR MANIPULATING ONSCREEN DATA”, Attorney Docket Number US34901, U.S. application Ser. No. ______, Filed on ______.

### BACKGROUND

1. Technical Field

The present disclosure relates to a computer-implemented method for manipulating onscreen data.

2. Description of Related Art

Electronic devices, such as e-books, allow users to input content. The users can input the content using a stylus or a finger if the electronic device is touch-sensitive. If the user wants to manipulate (e.g. copy/paste) on screen content, the user must activate a command mode. For some electronic devices, touching the screen with the stylus or finger for more than a predetermined period of time will activate the command mode. Then the user manipulates the content. However, some users may find it inconvenient to have to wait the predetermined period of time each time they want to manipulate onscreen data.

### BRIEF DESCRIPTION OF THE DRAWINGS

FIG. 1 is a block diagram of an embodiment of a system for manipulating onscreen data.

FIG. 2 shows a schematic view of inputting content of an embodiment of the method for manipulating onscreen data.

FIG. 3 shows a first schematic view of starting a command mode of the method for manipulating onscreen data.

FIG. 4 shows a second schematic view of starting the command mode of the method for manipulating onscreen data.

FIGS. 5-8 show a schematic view of starting the command mode through a frame round.

FIG. 9 shows a schematic view of divisions of a touch screen operable as a command menu.

FIG. 10 shows a schematic view of selecting a command.

FIG. 11 shows a schematic view of popping a menu.

FIG. 12 shows a schematic view of continuing inputting after inputting a circle.

FIG. 13 shows a schematic view illustrating a touch path on a display.

FIG. 14 shows a schematic view of the finger selecting the command.

FIG. 15 shows a schematic view of drawing lines away from the menu.

FIG. 16 shows a schematic view of the menu disappearing.

FIG. 17 shows a schematic view of canceling the menu.

FIG. 18 shows a schematic view of deleting a selection.

FIG. 19 shows a schematic view of copying a selection.

FIG. 20 shows a schematic view of copying part of a paragraph.

FIG. 21 shows a schematic view of pasting the paragraph.

FIG. 22 shows a schematic view of replacing with the paragraph.

FIG. 23 shows a schematic view of deleting the graph.

FIG. 24 shows a flowchart of the method for manipulating onscreen data.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

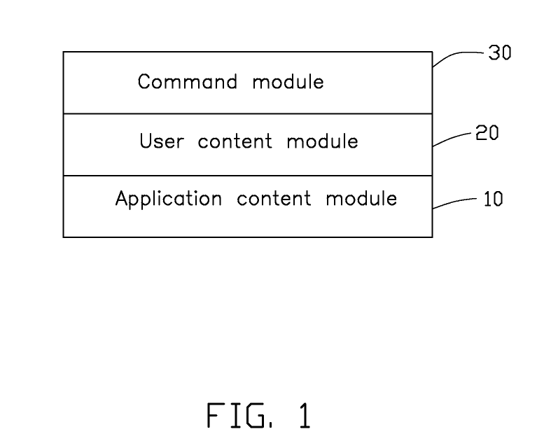

Referring to FIG. 1, a system for manipulating onscreen data includes an application content module 10, a user content module 20, and a command module 30. The system can be used to facilitate user interaction with onscreen data, an electronic device installed with the system, and applications installed in the electronic device. Such interaction may include, among other operations, word processing, text editing, image labeling and editing, mode selection, and menu item selection. The interaction is accomplished through touch input by a user on a touch sensitive screen of the electronic device. Touch input can be assumed to be performed either by finger touch, stylus, or other suitable implement, and the user content module will cause corresponding line or marks to appear onscreen corresponding to the path of the touch input. The application content module 10 is an interface in communication with applications of the electronic device (e.g. a road map application and an e-book reader application) which allows user interaction with and manipulation of application data on display. The user content module 20 receives and allows manipulation of user input displayed onscreen. When the user reads e-books, the user may input text and/or marks related to the e-book text, and edit the text and/or marks, by touch. The command module 30 is an interface used for entering or changing command modes of the system. In one such command mode, user input is recognized by the application content module 10 and/or the user content module 20, and in response an operation, (e.g., selection and copying of content) is performed. In one embodiment, the user may select text which is copied to a clipboard of the device, and it can then be pasted into content of another application, such as in a letter of an email application.

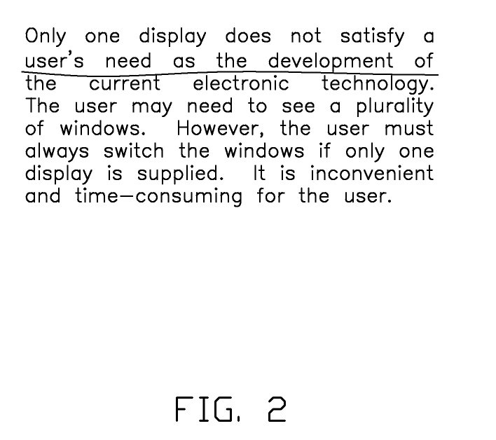

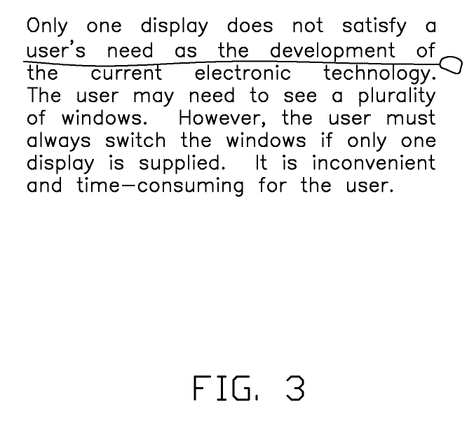

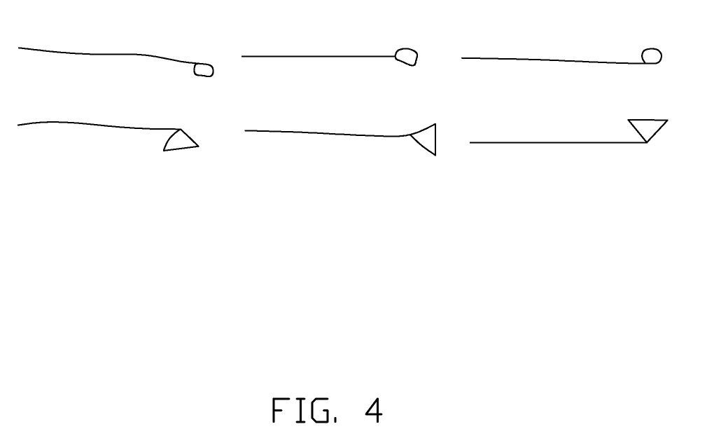

Referring to FIGS. 2-4, user input is illustrated. In one embodiment, the user draws a line (selecting path) by touch under a sentence and then finishes the line drawing movement (completes the touch path) by drawing a roughly circular shape without break. When the user draws a circle, or an approximation of a circle (command initiating path), at the end of the line, the system enters a command mode. Both drawings of selecting path and command initial path are displayed on the touch screen. The line and the circle will be recognized as a selection-command input. The circle will not be completed every time. It should recognize the circular pattern, even if it is not even it does not form a completed circle. In this particular example, the command mode allows, among other things, the recognition of touch path immediately preceding the drawing of the circle to be a selection command. Thus, at this time, the sentence underscored by the drawn line is selected. FIG. 4 shows several examples of predetermined recognizable selection touch paths followed by command initiating touch paths to select onscreen content from the application content module 10 or the user content module 20. It is notable that the closed shape initiating a command mode need not be precise but can just roughly approximate predetermined shapes such as a circle or triangle as given in example here. In this disclosure, circle may be construed as including any enclosed shape preselected to be recognized as command mode activation and mode change input. As mentioned before a circular pattern will be recognized, even if it is not a completed circle. The user can make a selection and start the command mode using the same method in any application within the system.

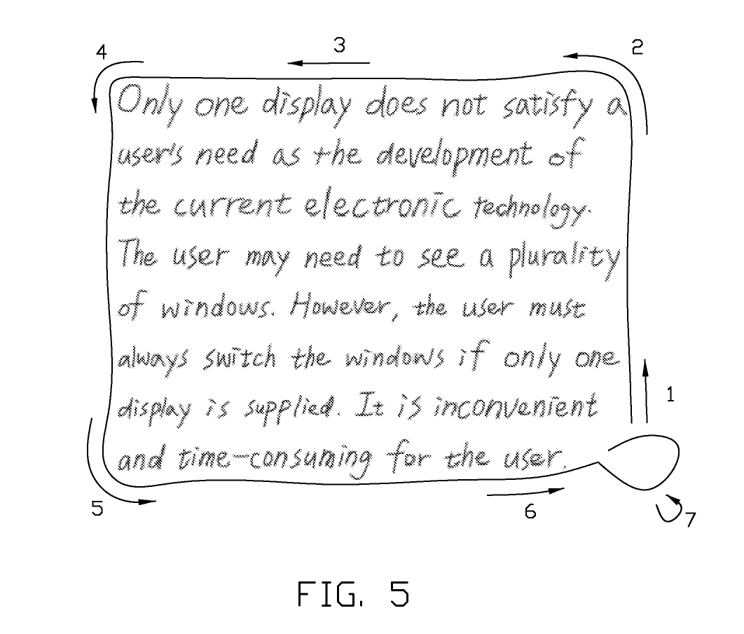

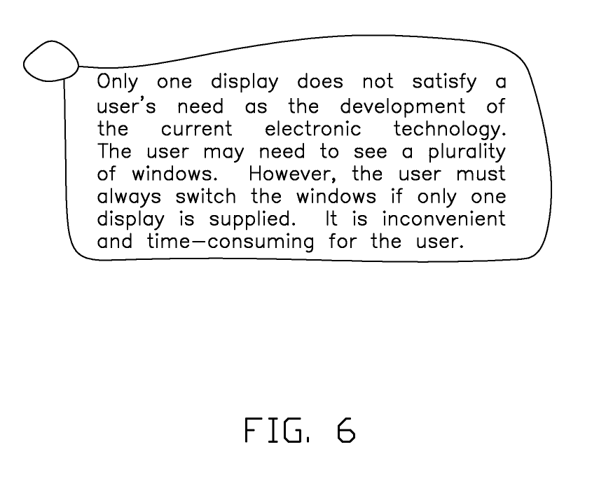

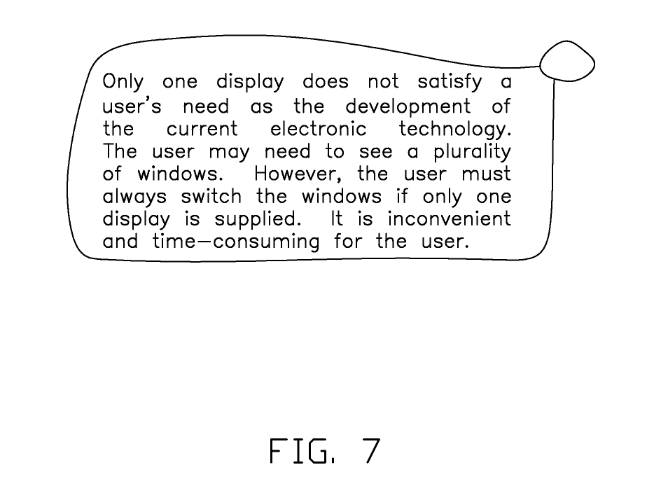

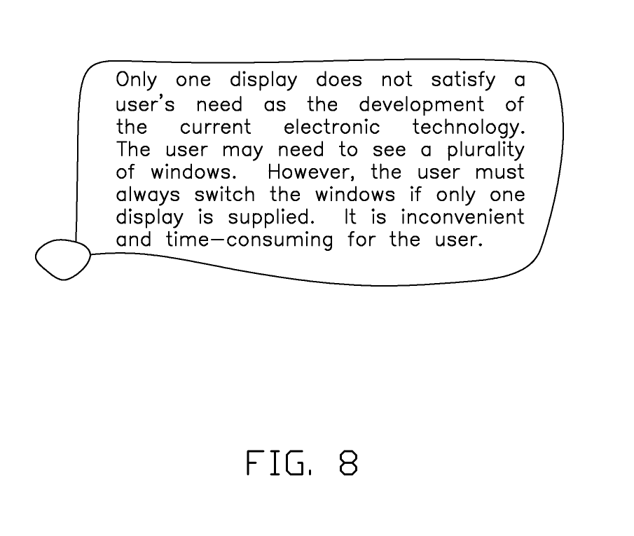

Referring to FIGS. 5-8, the user can encircle a desired portion of the content for selection by touch. One such example of a recognizable selection and command touch path is illustrated in FIG. 5 with the order in which the various parts of the path were drawn indicated by the sequence of numbers 1, 2 . . . 6. Finally, the user draws the circle to start the command mode. The user can then manipulate onscreen content, and perform actions such as copy/cut. FIGS. 6-8 show several examples of selection and command touch paths.

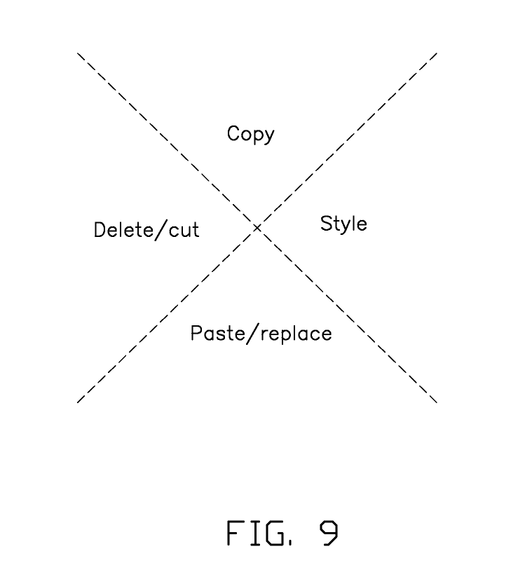

Referring to FIG. 9, during operation of a display on an electronic device, when the device is in a command mode, the display may be divided into four command areas requiring a third part be added to the selection and command touch path to select or specify a specific function or action to be performed on the selection. The third part of the touch path should be a line drawn from the circle entering one of the divisions thus selecting the function or action associated with that division. In one embodiment, a top area of the display is associated with copy selection command; the bottom area of the display is associated with paste/replace selection command with item copied to clipboard; the left area of the display is associated with delete/cut selection command; and the right area of the display is associated with the style command.

The copy selection command copies the selected content to the clipboard. The delete/cut selection command means to cut the selection and copy it to the clipboard. The replace command means to replace the selection with contents in clipboard. The style command may change a style of the selection through further command buttons on a popup tool bar, such as changing size or color of the selection, or highlighting the selection. It should be noted that these commands and the number of command areas are not limited to this example but may be other commands/functions/actions and there may be more or fewer than 4 divisions.

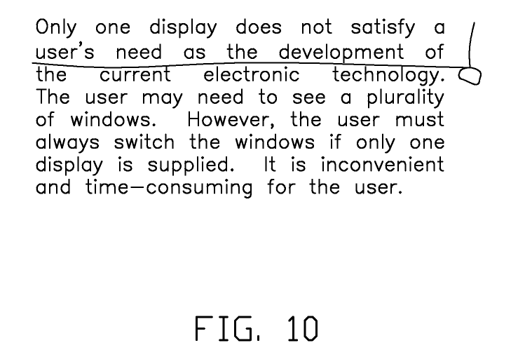

Referring to FIG. 10, the user draws a line up after the user draws the selection and command path by touch to select the copy selection command, down to select paste or replace selection command, left to select delete or cut selection command, and right to select style command. After indicating one of the commands, the drawings of selecting path and command path disappear.

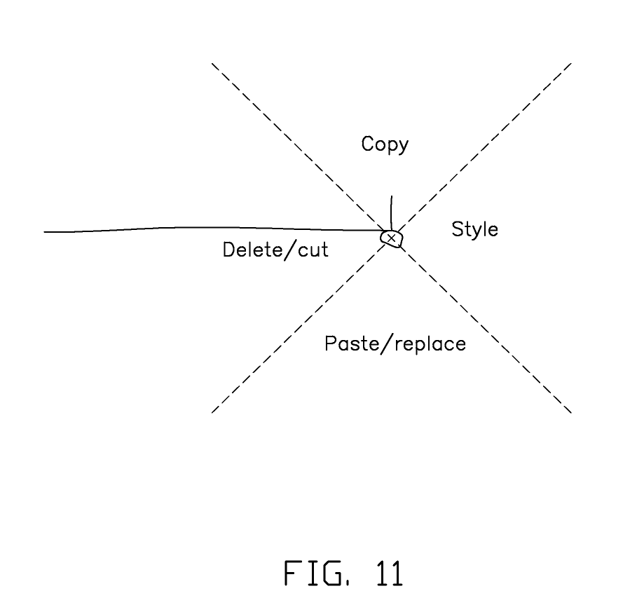

Referring to FIG. 11, if when the user initially touches the display but lingers in place rather than proceeding to follow a selection path, or hesitates and lingers at any point up to completing the command portion of the path, such as for more than 0.5 seconds, a menu or dialog window will pop up to inform the user what is needed to complete the path and choose a command. Then the user can complete the selection, command activation, and command selection path or cancel the command by tapping outside the command menu area.

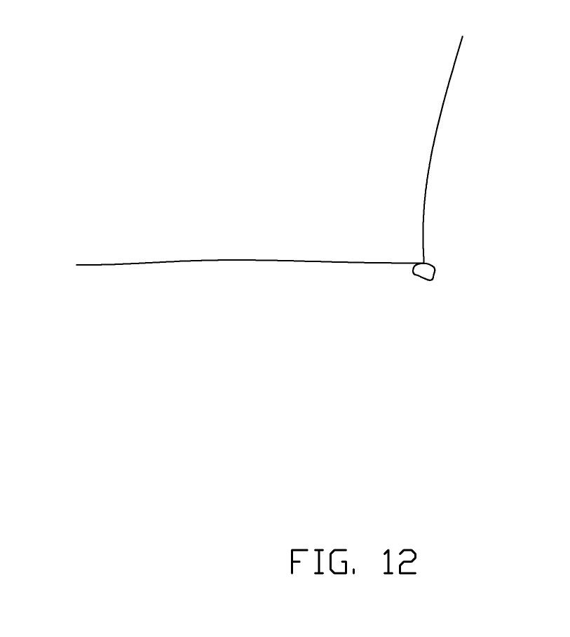

Referring to FIG. 12, a limiting parameter may be defined wherein if the user continues drawing the command selection portion of their input for more than a predetermined period of time (e.g. 1 second) and/or longer than a specified distance (e.g. 200 pixels) after the user draws the circle, the system treats the input as having been aborted and the process ends and drops out of command mode. The lines and circles remain shown on the display as drawing lines.

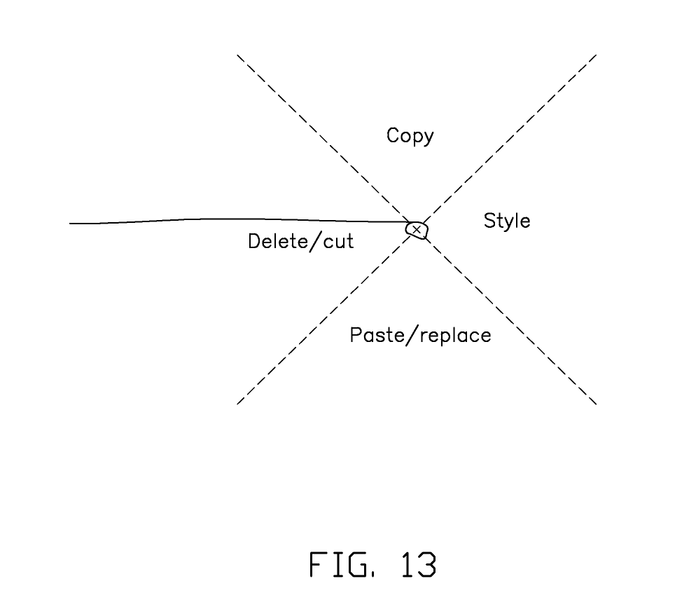

Referring to FIG. 13, if a user input ceases after drawing the circle, an onscreen menu appears indication the divisions and commands/functions/actions associated with each division. The user can then resume the input from the general area of the center of the menu and press on the division associated with desired command. If the user does not touch the display for more than a predetermined period of time (e.g. 2 second) after the user draws the circle, the menu may disappear. The lines and circles remain shown on the display as drawing lines.

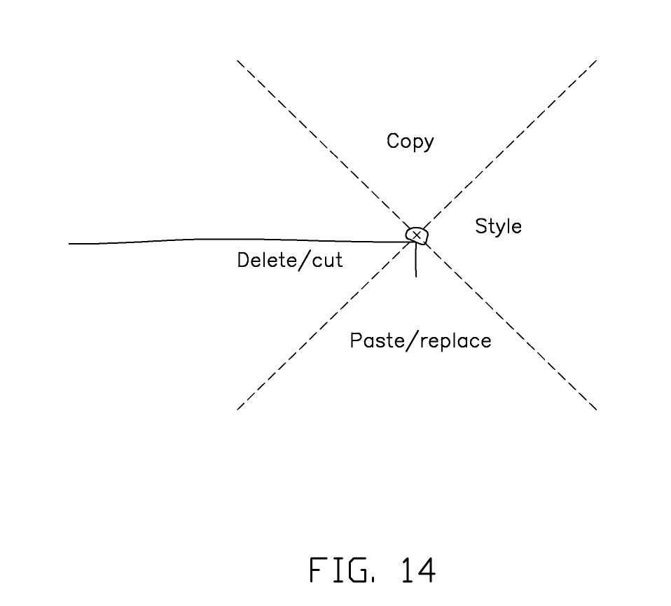

Referring to FIG. 14, if a user is already familiar with command choices, there is no need to display the command choices every time. In this case, the user can draw the command selection path immediately after drawing the circle (for command activation), the command associated with the direction of the command selection path is performed right away without displaying the on-screen menu for the command choices. The command may be one of the 4 commands shown in FIG. 14.

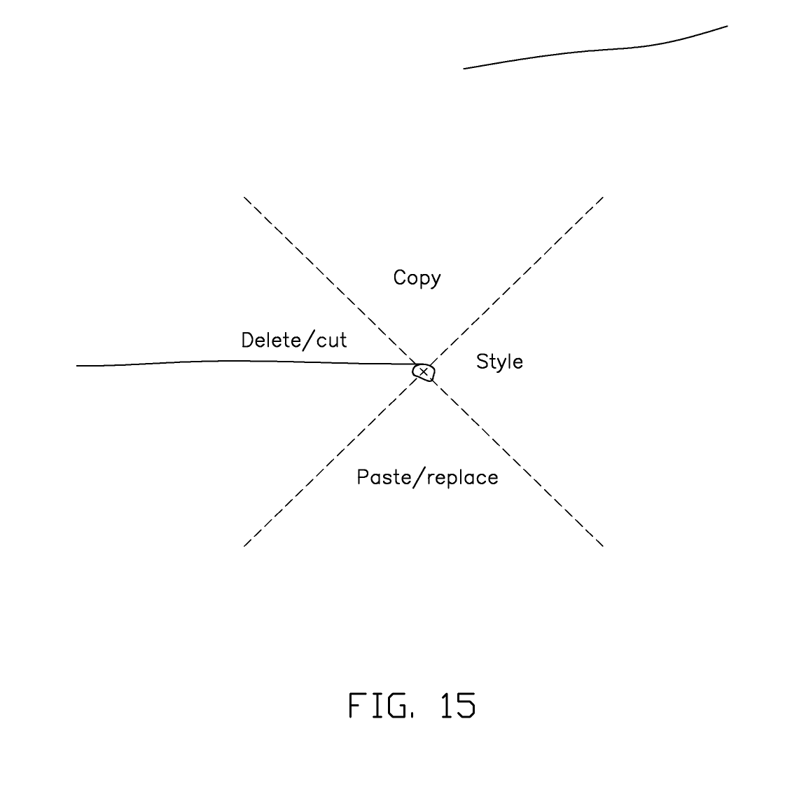

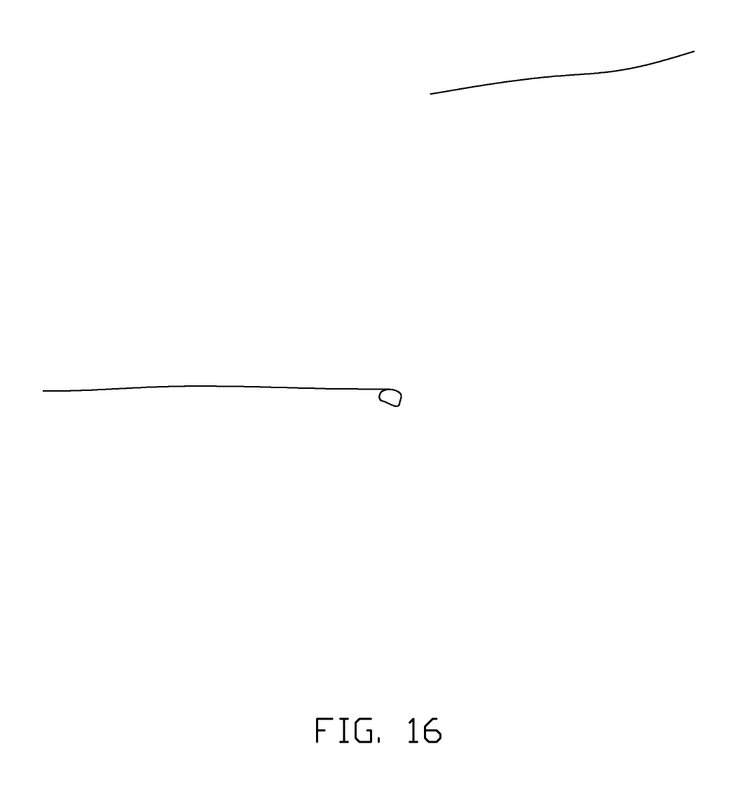

Referring to FIGS. 15 and 16, if a user input ceases after drawing the circle, an onscreen menu appears indicates the divisions and commands/functions/actions associated with each division. The user continues to draw the lines or press the display outside the menu. The menu will disappear. The lines and circles remain shown on the display.

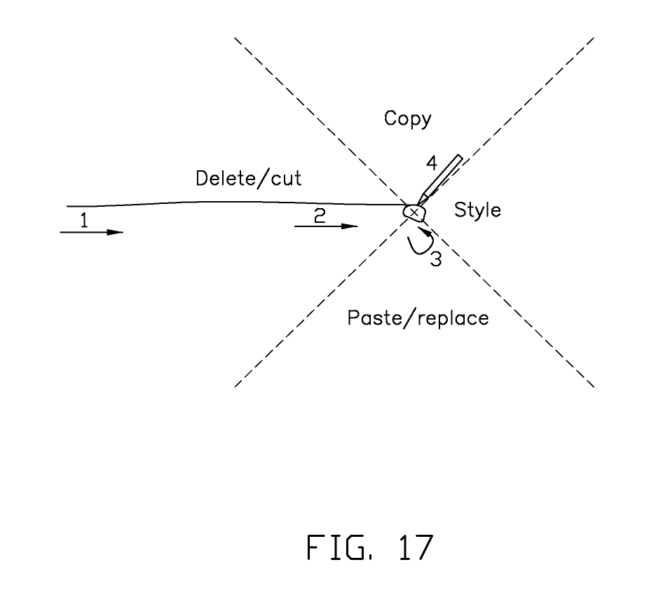

Referring to FIG. 17, if a user input ceases after drawing the circle, an onscreen menu appears and indicates the divisions and commands/functions/actions associated with each division. When the user presses or taps the middle of the menu (a hidden cancel button), it cancels the command mode, the menu, and all lines and marks related to current input will be deleted or removed from view.

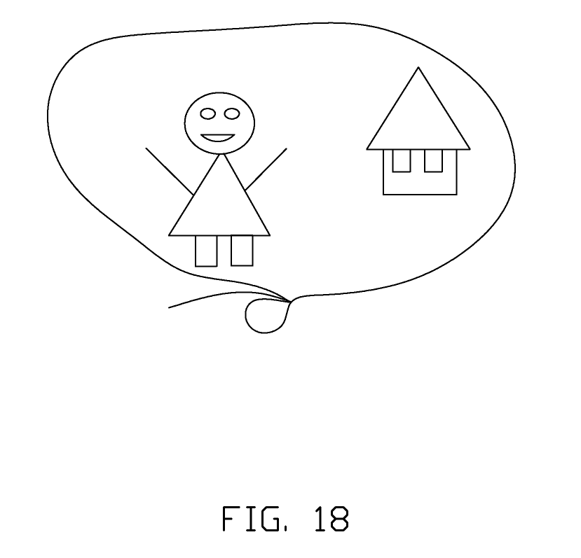

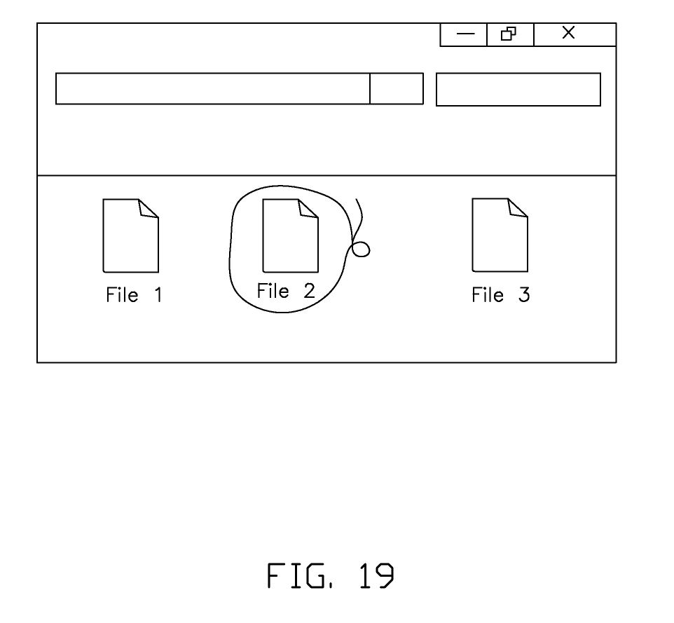

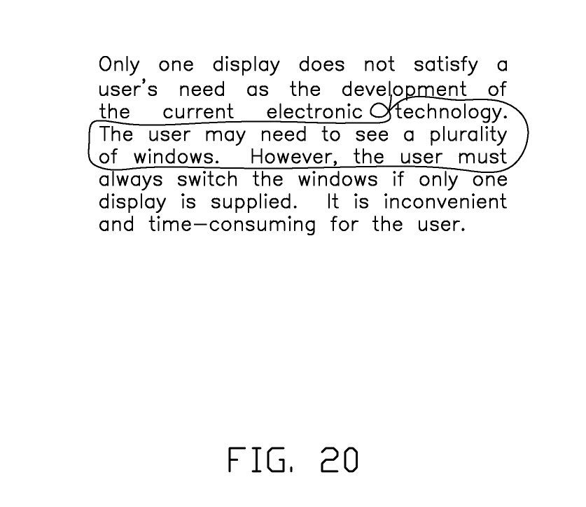

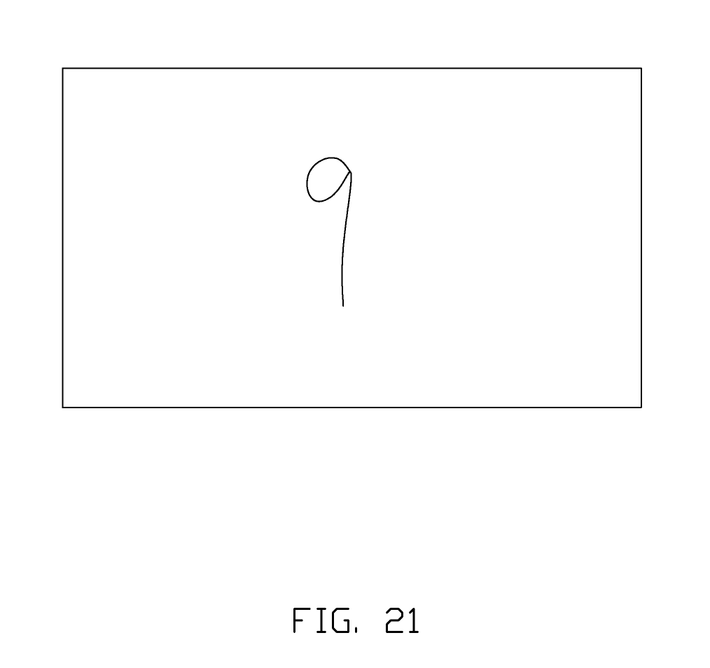

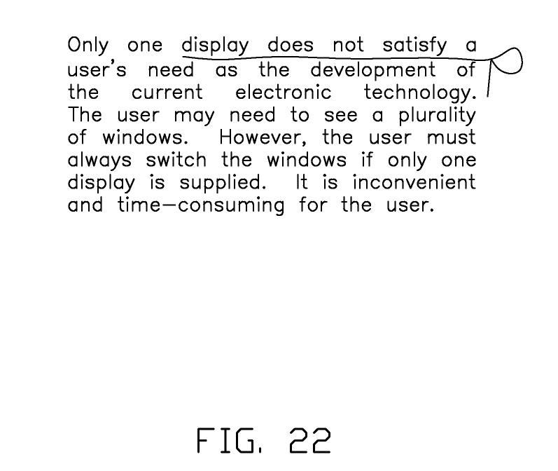

Referring to FIGS. 18-22, FIG. 18 shows an example of how delete/cut a picture according to an embodiment. FIG. 19 shows to copy a file according to an embodiment. FIG. 20 shows to copy part of a paragraph according to an embodiment. FIG. 21 shows to paste the selected part of the paragraph of FIG. 20 according to an embodiment. FIG. 22 shows to replace “display does not satisfy a” with the copied/selected part of the paragraph of FIG. 20 according to an embodiment.

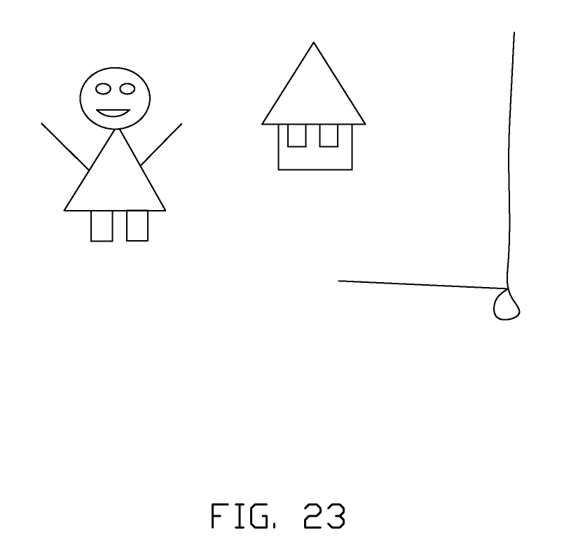

Referring to FIG. 23, the user can draw a line on a blank area of the screen to perform a select all action. The system selects all and executes the corresponding command. FIG. 23 shows an input path that begins at an upper portion of the screen and goes downward to a command circle then goes to the left to select delete/cut selection command, and all content, in this instance a menu is selected and cut and copied to clipboard.

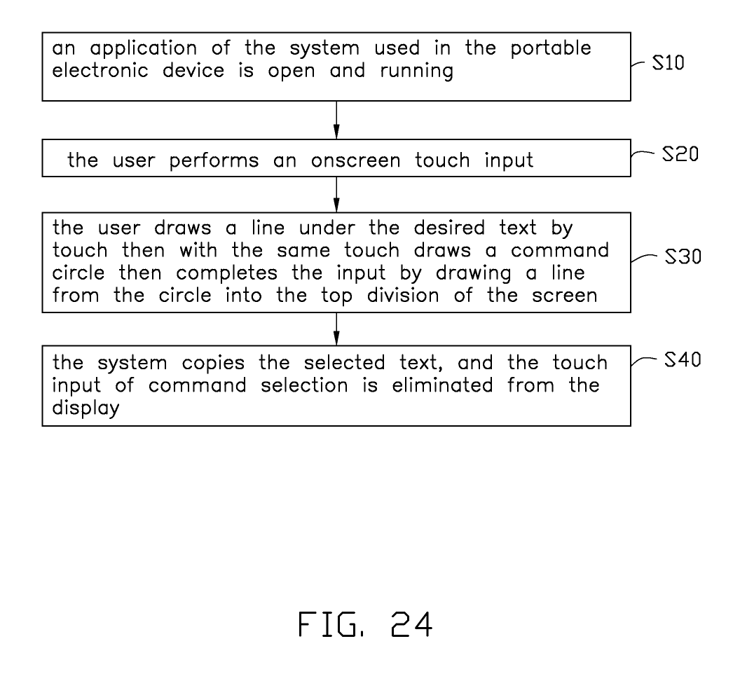

Referring to FIG. 24, one embodiment of a method for manipulating onscreen data includes the following blocks.

In block S10, an application of the system used in the portable electronic device is open and running.

In block S20, the user performs an onscreen touch input.

In block S30, the user draws a line under the desired text by touch then with the same touch draws a command circle then completes the input by drawing a line from the circle into the top division of the screen.

In block S40, the system copies the selected text, and the touch input of command selection is eliminated from the display.

It should be noted that the present method can save time and feel more convenient to users because there is no need to perform lingering touch inputs to activate or change command modes. However, this method does not proscribe lingering touches but rather can be used in addition to the lingering touches to ensure a broad range of input options such as what are needed for handicap accessibility.

While the present disclosure has been illustrated by the description of the embodiments thereof, and while the embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A computer-implement method for manipulating onscreen data, comprising:
displaying content on a touch-sensitive display;
receiving a touch path from the touch-sensitive display;
identifying a command initiating path from the touch path; and
executing at least one command operation.

2. The method of claim 1, wherein the command initiating path is a circular like pattern.

3. The method of claim 2 further comprising generating a command menu near the command initiating path to display an instruction for the at least one command operation.

4. The method of claim 3, wherein the command menu surrounds the command imitating path.

5. The method of claim 3, wherein the command menu is divided into a plurality of areas and each area is associated with a command.

6. The method of claim 1, wherein identifying the command initiating path from the touch path comprises determining the command initiating path and a selecting path, as a path traveled before the command initiating path.

7. The method of claim 1 further comprising displaying a track of the touch path on the display.

8. The method of claim 1, wherein the at least command operation comprises of four operations, the four operations comprise copy, cut, delete and paste.

9. A computer-implement method for manipulating onscreen data, the method comprising:
displaying content on a touch-sensitive display;
receiving a touch path from the touch-sensitive display;
identifying a command initiating path and a command executing path from the touch path; and
executing a command associated with the command executing path.

10. The method of claim 9, wherein the command executing path is identified as a substantially straight path at an end travel of the touch path.

11. The method of claim 10 further comprising identifying a travelling direction of the command executing path, wherein the command is associated with the travelling direction.

12. The method of claim 11, wherein the travelling direction is identified as one of an upward direction, a downward direction, a rightward direction and a leftward direction.

13. The method of claim 11, wherein the command is copy, cut, delete or paste.

14. The method of claim 9, wherein the touch path is continuous.

15. The method of claim 9, wherein the command initiating path is a circle pattern.

16. The method of claim 9, wherein identifying the command initiating path and the command executing path from the touch path further comprises determining the command initiating path and a selecting path.

17. The method of claim 9 further comprising displaying a track of the touch path on the display.

18. A computer-implement method for manipulating onscreen data, comprising:
entering a content input mode on a touch-sensitive display to execute a content input operation;
identifying a substantially close travelled touch path from the touch-sensitive display; and
switching from the content input mode into a command mode.

19. The method of claim 18 further comprising identifying a selecting path before identifying the substantially close travelled touch path to select the content.

20. The method of claim 19 further comprising determining a command executing path after identifying the substantially close travelled touch path.
